(19) United States
(12) Patent Application Publication
(10) Pub. No.: US 2021/0346897 A1
(43) Pub. Date: Nov. 11, 2021

(54) SINGLE-PIECE SHOWER HEAD

(71) Applicant: Marco Antonio GARCIA VILLARREAL, Monterrey (MX)

(72) Inventor: Marco Antonio GARCIA VILLARREAL, Monterrey (MX)

(21) Appl. No.: 17/286,500

(22) PCT Filed: Oct. 19, 2018
(86) PCT No.: PCT/MX2018/000107

§ 371 Date: Apr. 19, 2021

(51) Int. Cl. B05B 1/18

(52) U.S. Cl. CPC B05B 1/185

(57) ABSTRACT

The invention relates to a single-piece shower head having a single body that integrates a convex surface into which equidistant microducts disposed in concentric circles are incorporated and which has straight knurling on its lateral surface. The shower head also has a standard female thread for coupling simply and directly to any conventional shower arm.

This invention refers to a shower head, which is integrated by one piece only. More particularly, this invention refers to a one-piece shower head, to be installed mainly on the shower arm described in International Patent Application No. PCT/MX2018/000046, being able to be installed on any other shower arm since its coupling form is standard.

### FIELD OF THE INVENTION

### Background of the Invention

Nowadays there is a great variety of shower heads made of different materials such as metal or plastic, of different sizes, articulated, with flow regulator, water-saving, for high and low water pressure and with different designs in the rain beam.

There is a great variety of patents relating to shower heads which indicate a large number of ways to realize the rain beam. All patents speak of a shower head made with different materials and methods of construction in which more than one piece is incorporated, in general, patents relative to a shower head incorporate an element of union between the head and the shower arm, an element that allows the mobility of the head to direct the rain beam to where the user desires, a body of the shower head that may or may not include a water flow regulator, interior elements such as a filtering element and a lid from which the rain beam exits, shower heads may or may not be formed with these elements and even with others more.

### BRIEF SUMMARY OF THE INVENTION

The present invention relates to a single-piece shower head, which incorporates microducts in a convex surface, starting from the center five concentric circumferences with different amount of microducts perpendicular to said convex surface are incorporated, with a straight knurling on the lateral surface and which integrates to the interior a female thread, this shower head adapts to any type of shower arm by having a standard female thread.

This single-piece shower head invention is intentionally designed for the shower arm object of patent application PCT/MX2018/000046, being able to be used with any other shower arm since its female thread is standard.

### BRIEF DESCRIPTION OF THE DRAWINGS

FIG. 1 is a side view of the one-piece shower head.

FIG. 2 is a rear view of the one-piece shower head.

FIG. 3 is a front view of the one-piece shower head.

FIG. 4 is a side view in section A-A of the one-piece shower head.

FIG. 5 is an isometric view of the one-piece shower head.

FIG. 6 is an exploded isometric view of the coupling of the one-piece shower head with an ordinary shower arm.

### DETAILED DESCRIPTION OF THE DRAWINGS

The one-piece shower head will be described in greater detail in reference to the drawings.

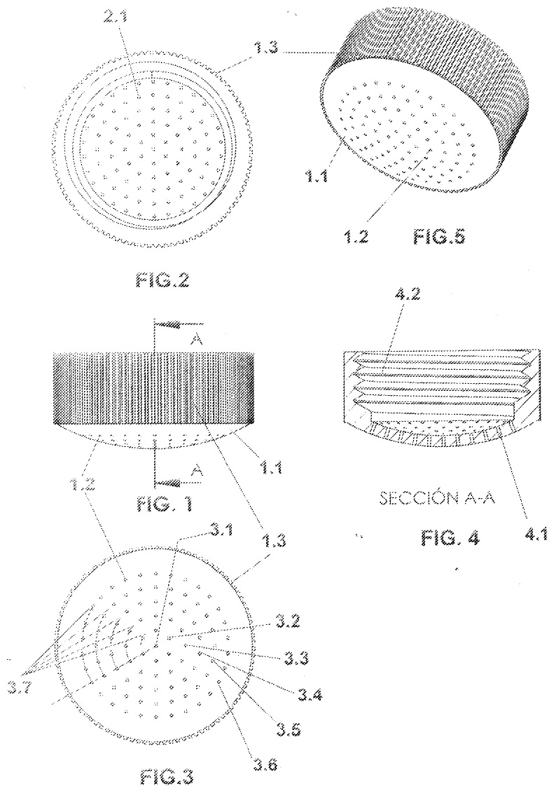

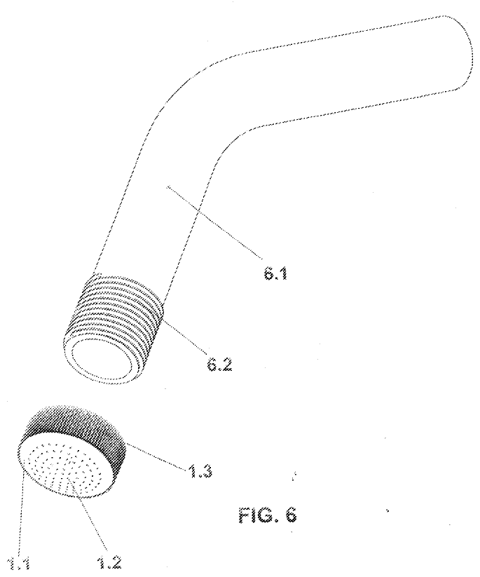

The one-piece shower head (FIG. 5) is made of metal material such as brass but can be made of any material such as plastic. It has a convex surface (1.1) with perpendicular microducts (FIG. 4, 4.1), preferably 91 in number, distributed in concentric circles (FIG. 3, 3.7), one microduct at the center (3.1), 6 in the first circumference (3.2), 12 in the second circumference (3.3), 18 in the third circumference (3.4), 24 in the fourth circumference (3.5) and 30 in the fifth circumference (3.6), the number of concentric circumferences (3.7) as well as the number of microducts (4.1) may vary. These microducts are distributed equidistantly from each other in each of the circumferences, in (FIGS. 1, 3, 5 and 6) the exit holes (1.2) of the microducts (4.1) are shown, in (FIG. 2) the entry holes (2.1) of the microducts are shown (4.1), in the side wall there is a straight knurling (1.3) for adjustment with the fingers of the hand on the shower arm. Said knurling can also be made in the form of rhombuses, to the inside of the single-piece shower head there is a standard female thread (4.2) specially designed to be integrated to the shower arm object of the patent application PCT/MX2018/000046, it is standard because it adapts to any common shower arm, in the (FIG. 6) a conventional shower arm (6.1) with standard male thread (6.2) has been incorporated in correspondence with the one-piece shower head, object of the present application.

1. Single-piece shower head, essentially characterized by comprising a single body that integrates a convex surface in which microducts have been incorporated equidistantly arranged in concentric circles and that on its lateral surface has a straight knurling, also having a standard female thread for simple and direct coupling to any conventional shower arm.

2. One-piece shower head according to claim 1, essentially characterized by containing on the convex surface a series of 91 microducts distributed in 5 concentric circumferences and 1 microduct in the center; having 6 microducts the first circumference, 12 microducts the second circumference, 18 microducts the third circumference, 24 microducts the fourth circumference and 30 microducts the fifth circumference.

3. One-piece shower head according to claim 2, essentially characterized by containing on its convex surface a series of concentric microducts and circumferences whose quantities may vary.

4. Universal one-piece shower head according to claim 1, essentially characterized by incorporating a standard thread primarily adaptable to the shower arm subject of patent application PCT/MX2018/000046, furthermore it is directly adaptable to a conventional shower arm.

5. Shower head, according to claim 1, essentially characterized by incorporating a straight knurling for easy installation.
